(19) United States
(12) Patent Application Publication
(10) Pub. No.: US 2005/0105664 A1
(43) Pub. Date: May 19, 2005

(54) Process for generating nuclear heat

(76) Inventor: Talbot Albert Chubb, Arlington, VA (US)

Correspondence Address: Melvin L. Crane, 318 South Cleveland Street, Arlington, VA, 22204-2038, US

(21) Appl. No.: 10/696,645

(22) Filed: Oct. 30, 2003

(51) Int. Cl. G21J 1/00

(52) U.S. Cl. 376/100

(57) ABSTRACT

A deuterium-fueled heat source that utilizes solid state electrolysis device(s) that deposit D atoms onto, and remove D atoms from, a metal reactor plate containing deuterium diffusion-impeding barriers.

### RELATED PATENT APPLICATION

This application is copending with a related patent application for an Apparatus for Generating Nuclear Heat filed on the same date, which was 30 Oct. 2003, serial number.

The invention relates to Disclosure Document Number 515131 filed in the U.S. Patent Office on 14 Jul. 2002 by applicant.

### FIELD OF THE INVENTION

This invention relates to heat generating processes and more particularly to heat generating processes in which deuterium participates in exothermic nuclear reactions in condensed matter. Further, the invention is directed to low energy nuclear reactions taking place in condensed matter, which includes radiationless cold nuclear fusion and other nuclear transmutations.

### SUMMARY OF THE INVENTION

The invention describes a process which causes deuterium to participate in exothermic nuclear reactions in a condensed matter environment. The process uses solid state electrolysis device(s) that deposit D atoms onto, and/or remove D atoms from, a metal reactor plate containing deuterium diffusion-impeding barriers. The process recirculates deuterium that has not participated in a nuclear reaction during an earlier passage through the metal reactor plate.

The process uses an assembly containing a metal reactor plate interfaced with either one or two solid-electrolyte layers. The assembly is mounted inside a containment enclosure pierced with hermetically sealed electrical feed-through fittings, and which is filled with deuterium gas D₂. The containment enclosure contains a metal reactor plate capable of absorbing deuterium, and which supports diffusion flow of deuterium in response to an internal deuterium density gradient. The reactor plate is fabricated so as to contain thin internal non-metallic layers parallel to its surface and of thickness such that the layers impede, but do not prevent deuterium diffusion flow within the plate. In a favored implementation of the process, the two exterior faces of the reactor plate are each coated with a solid state electrolyte. Each solid electrolyte layer is overcoated with a metal foil which is capable of dissolving deuterium. Metal foil, solid electrolyte, and contacting surface of the reactor plate form an electrolysis cell. There is an inflow electrolysis cell through which deuterium flows before entering the reactor plate, and an outflow electrolysis cell through which deuterium flows after leaving the reactor plate. The rims of the reactor plate, the two electrolyte layers, and the two metal foils are coated with an electrical insulator, which constitutes an annular rim insulator. The annular rim insulator is penetrated at the metal plate's rim with an electrical conducting wire, which passes through one of the feed-through fittings so as to permit connection to an external source of voltage and current outside the containment enclosure. Separate electrical wires make contact with the two metal foils, and pass through the wall of the containment enclosure through separate metal feed-through fittings. All wire passages through the walls of the containment enclosure are vacuum-tight sealed. A hermetic gas input tube penetrates the containment enclosure wall. The input tube is used to introduce D₂ gas into the cell during a preparation period during which a desired initial quantity of deuterium dissolves into the various metal components and a desired initial quantity of D₂ gas fills the containment enclosure. The gas input tube can be sealed off before process operation.

During process operation, D₂ gas is absorbed into the positive electrode of the front electrolysis cell. The absorbed deuterium passes through the front electrolysis cell and enters the front layer of the reactor plate, flows through the reactor plate where it is subject to scattering at the internal diffusion-impeding layers, mostly passes out the back surface of the reactor plate into the back electrolysis cell with its covering metal foil, and re-enters the gas volume of the containment enclosure as D₂ gas. This deuterium circulation is driven by serial voltage potentials applied across the inflow and outflow electrolysis cells. The scattering process converts some of the diffusing deuterium into a nuclearly active configuration. The nuclearly active configuration deuterium participates in exothermic nuclear reactions. Released nuclear energy converts into heat within the reactor plate. Subsequent heat transfer delivers the generated heat to a user application.

An alternate implementation of the process uses a single solid-electrolyte layer, which is interfaced with an outflow surface of the metal reactor plate and an outflow metal foil, forming thereby an outflow electrolysis cell. In this one-electrolysis-cell implementation of the process, inflowing D₂ gas adsorbs directly onto the inflow face of the reactor plate and absorbs into the interior of the reactor plate. The outflow electrolysis cell returns D₂ gas to the containment enclosure.

Another implementation of the process uses a single solid-electrolyte layer, which is interfaced with an inflow metal foil and with the inflow surface of the metal reactor plate, forming thereby an inflow electrolysis cell. In this input-electrolysis-cell implementation of the process, outflowing D₂ gas desorbs directly out of the outflow face of the reactor plate into the D₂ gas present within the containment enclosure.

Three alternate implementations of the process are identical to those described above, except that they replace the use of deuterium scattering from one or more diffusion-impeding non-metallic layers by the use of deuterium scattering from a dispersion of diffusion-impeding non-metallic inclusions.

### OBJECTS OF THE INVENTION

It is therefore an object of the invention to provide a device from which nuclear energy is released and converted to heat within a reactor plate;

Another object of the invention is to provide heat from nuclear energy by use of nuclear reactions in which deuterium participates as a reactant;

Still another objective is to provide heat from nuclear energy without the emission of energetic particles, neutrons, or gamma radiation, such as accompanies heat generation in commercial nuclear power plants;

Yet another object is to provide heat from nuclear energy in a device that is small enough to be suitable for heating a room.

### BRIEF DESCRIPTION OF THE DRAWINGS

FIGS. 1, 2, and 4 are schematic cross sectional drawings illustrating two different assemblies that implement the invention;

FIG. 1 is an edge view of an assembly that supports left-to-right deuterium permeation through a reactor plate;

FIG. 2 is a front end view of the assembly shown in FIG. 1;

FIG. 3 is an approximate one-million-times-magnified scaled cross sectional view of a portion of FIG. 1 showing detail not shown in FIG. 1; and

FIG. 4 is an alternative assembly that supports upward deuterium flow through a reactor plate.

### DETAILED DESCRIPTION

The process generates heat by exothermic nuclear reactions in which deuterium participates, and uses solid state electrolysis device(s) that deposit D atoms onto, and/or remove D atoms from a metal reactor plate containing deuterium diffusion-impeding barriers. Deuterium that fails to participate in a nuclear reaction during passage through the metal reactor plate is recirculated. The process can be carried out using a number of alternate hardware assemblies. The Figures illustrate two such assemblies.

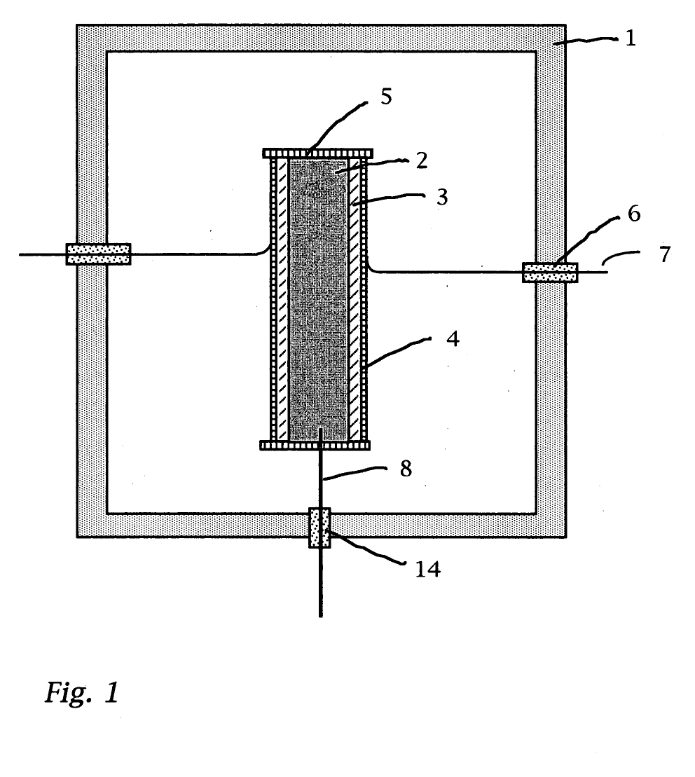

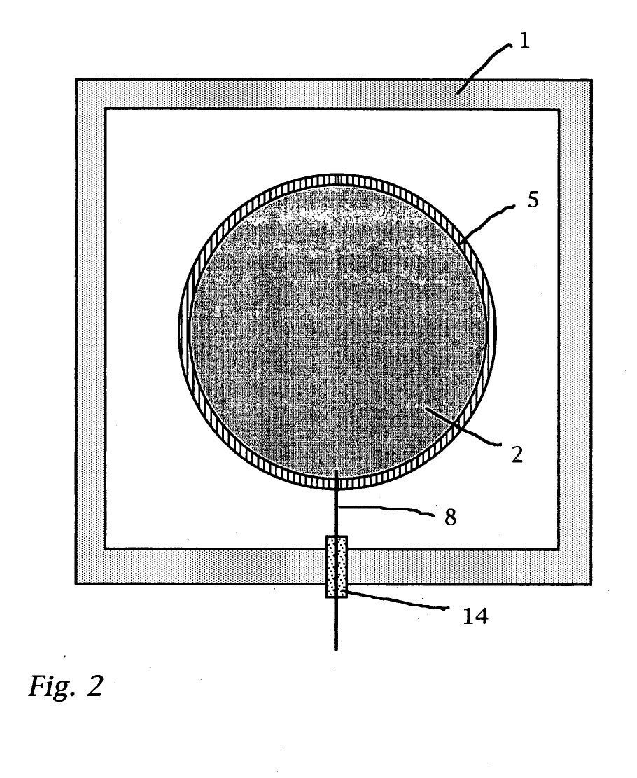

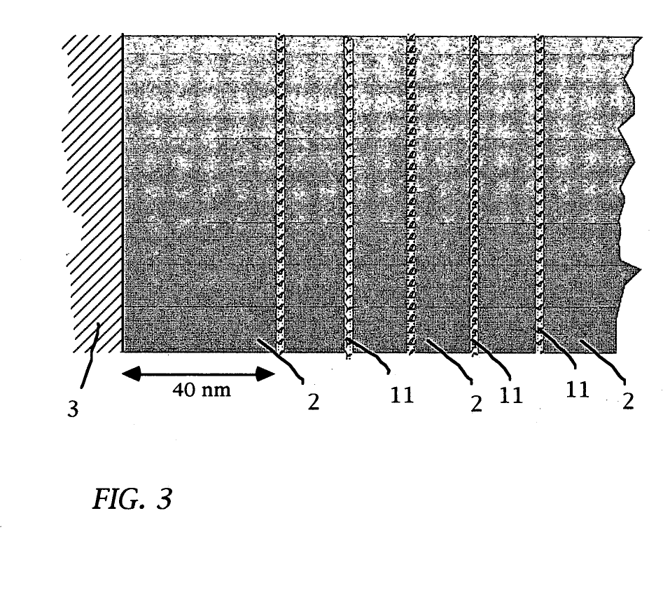

Now referring to FIGS. 1 and 2, pressure tight containment enclosure 1 is formed by aluminum, steel or other impervious metal, and contains an interior assembly comprising a flat metal reactor plate 2 interfacing on its left and right side planar surfaces with left and right layers of solid electrolyte 3. The reference characters in FIGS. 1 and 2 identify the right side components, but apply equally to the left side components. Both left and right layers of solid electrolyte 3 make surface contact with left and right metal foils 4. Reactor plate 2 is made of Pd. Now referring to FIG. 3, within reactor plate 2 there is a left-side grouping of five layers 11 of CaO. The CaO layers are not shown in FIG. 1. The CaO layer closest to the left surface of reactor plate 2 is located about 40 nm inward and parallel to the left planar surface of the plate. The layers of CaO are 2 nm thick. Within the grouping, the CaO—CaO layer separation is about 18 nm. The thickness, separation, and distance of the CaO layers from the closest metal surface of reactor plate 2 are as taught by Y. Iwamura, M. Sakano, and T. Itoh, Jpn. J. Appl. Phys. 41A, pp. 4642-4650, (2002), by Y. Iwamura, T. Itoh, M. Sakano, and S. Kuribayashi, in ICCF10 Abstracts, Presentation Tu15, (2003), and by T. Higashiyama, M. Sukano, H. Miyamaru, and A. Takahashi, ICCF10 Proceedings preprint, distributed through www.LENR-CANR.org, pp. 1-6, (2003). Iwamura et al. fabricated their test reactor plates, which have the desired internal layer construction, by starting with a plate of commercially pure Pd metal, coating the reactor plate with a sequence of five 2-nm layers of sputtered CaO, separated by four 18 nm layers of sputtered Pd metal, and topped with a 40-nm layer of sputtered Pd metal. The layers were deposited using argon ion beam sputtering. Left and right solid electrolyte layers 3 are deposited layers of poly ethylene oxide (PEO), containing deuterided phosphoric acid, as taught by Biberian and G. Lonchampt, Proc. ICCF9 (2002), in “Condensed Matter Nuclear Science”, ed. by Xing Z. Li (Tsinghua University Press, China, 2003) pp. 17-22. Each layer is about 1 mm thick and is a deuteron conductor. The hydrided version of the specified electrolyte has been used in the prior art in lithium batteries, where it operates between 70° C. and 120° C. Left and right electrolyte layers 3 are each covered with a contacting piece of metal foil 4. Left and right metal foils 4 are made of Pd or Pd-alloy, and are about 0.1 mm thick. The rim surfaces of reactor plate 2, left and right electrolyte layers 3, and left and right metal foils 4 are held in place by annular rim insulator 5, which may be of poly tetrafluoroethylene plastic (PTFE). The left and right hermetically sealed feed-through insulators 6, which may be made of a ceramic, are sealed to left and right electrical wire leads 7. Left wire lead 7 makes contact with left metal foil 4, and right wire lead 7 makes contact with right metal foil 4. Left and right wire leads are made of Ni. The bottom wire lead 8 passes through feed-through insulator 14 and makes contact with reactor plate 2 by piercing the annular rim insulator 5, as shown in FIGS. 1 and 2. Bottom wire lead 8 is made of Ni. It supports the sub-assembly consisting of reactor plate 2, left and right electrolyte layers 3, left and right metal foils 4, and annular rim insulator 5. Gas supply tube 12 pierces a wall of containment enclosure 1, and is used to fill containment vessel 1 with D₂ gas prior to use, and to furnish pre-operation conditioning D₂ gas which is absorbed by the metal components during conditioning of the system prior to process operation. Square box 13 schematically represents a pressure transducer that produces an electrical output voltage which measures gas pressure inside pressure tight vessel enclosure 1.

Prior to process operation, containment vessel 1 is filled with D₂ gas and is heated to above about 70° C. During process operation, wire lead 8 may be connected to ground electrical potential, which is defined as reference potential V=0 volts. Left metal foil 4, left solid electrolyte layer 3, and left surface of metal plate 2 form a left electrolysis cell. The left electrolysis cell is the inflow electrolysis cell. Right metal foil 4, right solid electrolyte layer 3, and right surface of metal plate 2 form a right electrolysis cell. The right electrolysis cell is the outflow electrolysis cell. Left wire lead 7 is connected to an external power supply providing an electrical potential V_{L}, which is positive relative to the left cell zero-current cell potential V_{Lo}, thereby polarizing the left cell so as to drive a deuterium permeation flow toward the right. Right wire lead 7 is connected to an external power supply providing an electrical potential V_{R}, which is negative relative to the right cell zero current cell potential V_{Ro}, thereby polarizing the right cell so as to drive a deuterium permeation flow also toward the right. As taught by Biberian and Lonchampt, current flow through left electrolyte removes deuterium dissolved in left metal foil 4 and deposits deuterium onto metal plate 2, which absorbs the deposited deuterium. As taught by Biberian and Lonchampt, left-to-right current flow through right electrolyte 3 desorbs deuterium from metal plate 2 and deposits deuterium onto right metal foil 4, which absorbs the deuterium. Concurrently D₂ gas adsorbs and dissociates on the left surface of left metal foil 4 and desorbs from the right surface of right metal foil 4 into the gas.

During process operation, absorption of deuterium on the left surface of reactor plate 2 and concurrent desorption of deuterium from the right side of reactor plate 2 drives a left-to-right permeation flow of deuterium through reactor plate 2. This permeation flow resembles that used in the studies by Iwamura et al. (2002 and 2003) and Higashiyama et al. (2003), which studies have demonstrated deuterium participation in exothermic nuclear reactions. In “The dd Cold Fusion-Transmutation Connection” by T. A. Chubb, ICCF10 Proceedings preprint, distributed through www.LENR-CANR.org, pp. 1-15, (2003a), a quantum mechanics wave equation-wave function model explains how the prescribed permeation flow leads to exothermic nuclear reactions. The model assumes that impeded deuterium permeation flow creates a nuclearly active configuration of wavelike deuterium, which behaves much like the conduction electron medium in a metal. Quantum mechanics uses the term “Bloch function” to described the deuterium configuration. The conduction electrons in a metal have a similar delocalized wavelike form and provide a low resistance conduction current flow in response to a voltage potential difference across a metal crystal. Similarly, wavelike deuterium provides a low resistance deuterium conduction permeation flow in response to a difference in the chemical potential of wavelike deuterium across a metal crystal.

The total deuterium permeation flow is modeled as being partitioned between a relatively large diffusion flow of non-nuclearly-active interstitial deuterium within the metal and a relatively small conduction flow carried by nuclearly-active wavelike deuterium. The normal form of deuterium in a metal is the non-nuclearly-active interstitial configuration. The normal diffusion flow is driven by a concentration gradient of deuterium in self-trapping potential wells. The normally occupied potential wells in Pd metal are known to be centered on the octahedral sites of the face-centered cubic (fcc) metal lattice. The conduction flow is modeled as being carried by wavelike deuterons occupying shallower, non-self-trapping potential wells. These wells are believed to be centered on the tetrahedral sites of the fcc metal lattice, as explained in “LENR: Superfluids, Self-Trapping and Non-Self-Trapping States”, T. A. Chubb, ICCF10 Proceedings preprint, distributed through www.LENR-CANR.org, pp. 1-4, (2003b). At each of the CaO diffusion-impeding layers there is a scattering of both types of deuterium. The scatterings are modeled as reversible scatterings of individual deuterons between self-trapping and non-self-trapping sites. Reversibility requires that a fraction of the normally diffusing deuterons scatter into wavelike deuterons when they cross a diffusion-impeding layer. The resulting wavelike deuterons in the non-self-trapping sites are the nuclearly reactive component which, in the Iwamura et al. studies, spreads out and participates in exothermic nuclear reactions on the metal surface, releasing heat. The nuclear reactions demonstrated by Iwamura et al. and Higashiyama et al. are ¹³³Cs+8D→¹⁴¹Pr+50.5 MeV and ⁸⁸Sr+8D →⁹⁶Mo+˜53.5 MeV.

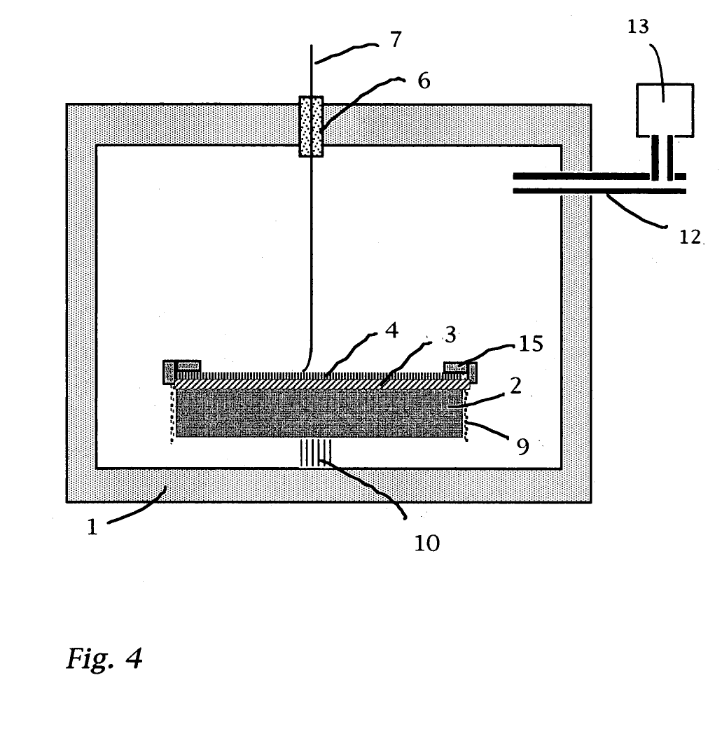

A second implementation of the process uses adsorption of gas directly onto the inflow surface of reactor plate 2 as the first step of a deuterium recirculation loop which includes passage of deuterium through reactor plate 2. Now referring to FIG. 4, pressure tight containment enclosure 1 contains an interior assembly designed to provide an upward deuterium permeation flow through reactor plate 2. In FIG. 4, reactor plate 2 is coated on its annular rim surface by insulator coating 9. Annular insulator coating 9 is made of a non-porous material such as PTFE. Reactor plate 2 is made of Pd metal and contains internally a grouping of diffusion-impeding CaO layers near its bottom planar surface, the internal layers are configured as described in FIG. 3. Reactor plate 2 is supported from the bottom surface of containment enclosure 1 by metal cylinder 10, which is of lesser diameter than reactor plate 2. As a result, a portion of the bottom surface of reactor plate 2 is exposed to D₂ gas within containment enclosure 1 during process operation. Reactor plate 2 makes contact with, and is covered by, solid electrolyte layer 3. Solid electrolyte layer 3 is made of poly ethylene oxide containing deuterided phosphoric acid. Solid electrolyte layer 3 makes contact with and is covered by metal foil 4, which is made of Pd metal. Metal foil 4 is positioned by annular positioning fixture 15, which is made of PTFE. The top surface of reactor plate 2, solid electrolyte layer 3, and metal layer 4 constitute an outflow electrolysis cell. Containment enclosure 1 is made of metal and is connected to electrical ground potential, designated V=0 volts. Wire lead 7, which is made of Ni, passes through feed-through insulator 6 to make contact with metal foil 4. During process operation, wire lead 7 is connected externally to an electrical power supply that keeps metal foil 4 at a potential V which is more negative than the zero-current cell potential Vₒ.

During process operation as implemented using the assembly configuration of FIG. 4, D₂ gas within containment vessel enclosure 1 dissociates on the exposed portion of the bottom surface of reactor plate 2. It is known from the prior art that D₂ gas dissociates into atom form when adsorbed onto dean Pd-like metals. The resulting surface atoms are absorbed into the metal of reactor plate 2. At the top surface of reactor plate 2, surface deuterium desorbs from reactor plate 2 and enters solid electrolyte 3 as deuterium ions. With the potential of metal foil maintained at V<Vₒ, D+ ion current flows through solid electrolyte 3 and deuterium is absorbed into the bottom surface of metal foil 4. Deuterium desorbs from the top surface of metal foil 4 as D₂ gas, completing the deuterium recirculation loop. The resulting upward permeation flow through reactor metal 2 creates nuclearly active deuterium as previously described.

Again referring to FIG. 4, a third implementation of the process uses the assembly of FIG. 4 but imposes a reverse electrical polarization of solid-electrolyte layer 3. The reverse polarization reverses the direction of deuterium circulation. The potential of metal foil 4 is maintained at V>Vₒ. D₂ gas within containment vessel enclosure 1 dissociates on the top surface of reactor plate 4, and desorbs downward into solid-electrolyte layer 3. Solid-electrolyte layer 3 functions as the electrolyte of an inflow electrolysis cell. Deuterium plating out of the electrolysis cell deposits onto the top surface of reactor plate 2 and dissolves into the bulk metal. The downward flowing deuterium is subject to scattering. Most of the inflowing deuterium desorbs from the bottom surface of reactor plate 2 as D₂ gas, completing the recirculation process. Optionally, the grouping of CaO layers may be near the top, middle, or bottom of reactor plate 2. In this third implementation of the process, the process takes place at a higher deuterium chemical potential and with a smaller deuterium gradient within the reactor plate than in the second implementation of the process, using the same assembly hardware.

Three additional implementations of the process are identical to the three implementations described above, except that they use a different internal diffusion-impeding structure within reactor plate 2. Instead of using thin non-metallic diffusion-impeding layers, the processes use an internal dispersion of non-metallic inclusions within reactor plate 2 as means for scattering nuclearly non-reactive diffusing deuterium into the nuclearly reactive configuration. Using a distribution of non-metallic inclusions resembling fragments of the diffusion-impeding CaO layers is within the scope of the invention provided that the impeding of deuterium permeation flow is sufficient to scatter amounts of deuterium into the nuclearly reactive state that are comparable to or greater than the amounts achieved by Iwamura et al. (2002).

In other options the process replaces unidirectional deuterium permeation flows within reactor plate 2 with back-and-forth deuterium permeation flow, by using a power supply or supplies that repeatedly alternate the potentials applied to wire leads(s) 7 between values more positive and less positive than the zero-current cell potentials.

Many modifications and variations of the assembly hardware supporting process operation are possible in light of the above teachings. Among these is that of replacing the planar sequence of component layers with a cylindrical sequence of the same functional elements. Also, it is well known in the art of fuel cell technology and in the physics of metal-hydrogen systems that one can coat a metal's surface with fine Pd powder or Pd—Ag alloy powder, thereby increasing the effective surface area for absorption of hydrogen into the metal's bulk. Also, it is well known in prior art that use of Pd coatings on a metal's de-oxidized surface can permit absorption of hydrogen into a metal's bulk for metals which form oxides that otherwise block absorption of hydrogen. Use of such surface treatments on the metal foil(s) and/or on the reactor plate, and use of metals other than Pd or Pd alloys for the foil(s) and/or reactor plate within the assembly should be considered as within the scope of the invention. Furthermore, use of internal non-metallic layers made of materials other than CaO within a reactor plate have been taught by Iwamura et al. The number, placement, uniformity, and thickness of the internal non-metallic layers can be widely varied provided that deuterium permeation is not prevented, and provided that the impeding of the deuterium permeation flow is sufficient to scatter amounts of deuterium into the nuclearly reactive state that are comparable to, or greater than the amounts achieved by Iwamura et al. (2002). For example, inclusion of both a left and right grouping of diffusion-impeding layers could be used with back and forth deuterium permeation flow through reactor plate 2 of FIG. 1. Addition of voltage control circuitry using signals from pressure transducer 13 together with temperature readings as a basis for setting the electrolysis cell voltages should be considered as within the scope of the invention. It is therefore to be understood that within the scope of the appended claims the invention may be practiced otherwise than as specifically described.

1. A process for generating heat by exothermic nuclear reactions in which reactions deuterium participates, and in which deuterium flows out of an electrically polarized solid-electrolyte layer into a metal reactor plate, and in which deuterium flows out of the metal plate into a second polarized solid-electrolyte layer, with the reactor plate containing one or more diffusion-impeding non-metallic layers.

2. The process of claim 1 in which at least one diffusion-impeding layer is made of CaO.

3. The process of claim 1 in which the metal reactor plate is made of metal selected from a group comprising Pd or Pd alloy.

4. The process of claim 1 in which the solid-electrolyte layers are made of poly ethylene oxide (PEO), containing deuterided phosphoric acid.

5. A process for generating heat by exothermic nuclear reactions in which reactions deuterium participates, and in which deuterium gas is adsorbed onto the inflow surface of a metal reactor plate, from which reactor plate deuterium flows out of the outflow surface of the reactor plate into an electrically polarized solid-electrolyte layer, with the reactor plate containing at least one diffusion-impeding non-metallic layer.

6. The process of claim 5 in which the one or more diffusion-impeding layers are made of CaO.

7. The process of claim 5 in which the metal reactor plate is made of metal selected from a group comprising Pd and Pd alloy.

8. The process of claim 5 in which the solid-electrolyte layer is made of poly ethylene oxide (PEO), containing deuterided phosphoric acid.

9. A process for generating heat by exothermic nuclear reactions in which reactions deuterium participates, and in which deuterium flows out of an electrically polarized solid-electrolyte layer into a metal reactor plate, and in which deuterium flows out of the metal plate into a second polarized solid-electrolyte layer, with the reactor plate containing a dispersion of diffusion-impeding non-metallic inclusions.

10. The process of claim 9 in which in which the non-metallic inclusions are made of CaO.

11. The process of claim 9 in which the metal reactor plate is made of metal selected from a group comprising Pd and Pd alloy.

12. The process of claim 9 in which the solid-electrolyte layers are made of poly ethylene oxide (PEO), containing deuterided phosphoric acid.

13. A process for generating heat by exothermic nuclear reactions in which reactions deuterium participates, and in which deuterium gas is adsorbed onto the inflow surface of a metal reactor plate, from the reactor plate deuterium flows out of the outflow surface of the reactor plate into an electrically polarized solid-electrolyte layer, with the reactor plate containing a dispersion of diffusion-impeding non-metallic inclusions.

14. The process of claim 13 in which the non-metallic inclusions are made of CaO.

15. The process of claim 13 in which the metal reactor plate is made of metal selected from a group comprising Pd or Pd alloy.

16. The process of claim 13 in which the solid-electrolyte layer is made of poly ethylene oxide (PEO), containing deuterided phosphoric acid.

17. A process for generating heat by exothermic nuclear reactions in which reactions deuterium participates, and in which deuterium gas flows from a deuterium gas reservoir into and through an input electrolysis cell containing a solid electrolyte layer interfaced with a metal reactor plate, from which reactor plate deuterium flows out of the outflow surface of the reactor plate into the deuterium gas reservoir, thereby completing a gas circulation loop, with the reactor plate containing at least one diffusion-impeding non-metallic layer.

18. A process for generating heat by exothermic nuclear reactions in which reactions deuterium participates, and in which deuterium gas flows from a deuterium gas reservoir into and through an input electrolysis cell containing a solid electrolyte layer interfaced with a metal reactor plate, from which reactor plate deuterium flows out of the outflow surface of the reactor plate into the deuterium gas reservoir, thereby completing a gas circulation loop, with the reactor plate containing a dispersion of diffusion-impeding non-metallic inclusions.

19. A process for generating heat by exothermic nuclear reactions in which reactions deuterium participates, and in which deuterium flows out of an electrically polarized solid-electrolyte layer into a metal reactor plate, and in which deuterium flows out of the metal plate into a second polarized solid-electrolyte layer, with the reactor plate containing at least one diffusion-impeding non-metallic layer, and in which process flow direction alternates in response to changes in potentials applied across the solid electrolyte layers.

20. A process for generating heat by exothermic nuclear reactions in which reactions deuterium participates, and in which deuterium flows out of an electrically polarized solid-electrolyte layer into a metal reactor plate, and in which deuterium flows out of the metal plate into a second polarized solid-electrolyte layer, with the reactor plate containing a dispersion of diffusion-impeding non-metallic inclusions, and in which the process flow direction alternates in response to changes in potentials applied across the solid-electrolyte layers.
